(19) United States
(12) Patent Application Publication
(10) Pub. No.: US 2026/0266545 A1
(43) Pub. Date: Sep. 10, 2026

(54) THERMAL DEHYDRATION SYSTEM AND METHOD

(71) Applicant: Renewable Thermal Solutions, LLC, Center, TX (US)

(72) Inventors: Bob Reeves, Center, TX (US); Howell Howard, Center, TX (US); Jim Donnan, Center, TX (US)

(21) Appl. No.: 19/556,223

(22) Filed: Mar. 4, 2026

Related U.S. Application Data
(60) Provisional application No. 63/767,925, filed on Mar. 6, 2025.

(51) Int. Cl. F26B 21/35; A22C 21/00

(52) U.S. Cl. CPC F26B 21/35; A22C 21/00

(57) ABSTRACT

A mortality dehydrator system includes a receptor volume configured to receive one or more animal carcasses, a heater system including at least one heater configured to heat the received one or more animal carcasses, a mixing system configured to mix the one or more animal carcasses during heating by the heater system, a blower system configured to circulate airflow during the heating by the heater system, a sensor system configured to detect a temperature within the receptor volume, and a control system configured to turn on or off the heater system in response to sensed information from the sensor system. Methods of thermal dehydration are further disclosed.

### RELATED APPLICATION

This claims priority to U.S. Provisional Patent Application No. 63/767,925 filed on March 6, 2025, the entirety of which is incorporated by reference herein.

### FIELD

The present invention relates to thermal dehydration, and more particularly to a method and system for poultry, livestock and/or mortality dehydration.

### BACKGROUND

A mortality dehydrator is a machine that uses heat to dispose of dead animals, such as poultry. Dehydrators are an alternative to composting, burying, or incinerating dead animals. Typically, dehydrators work by heating the carcasses in an enclosed drum, simultaneously mixing the carcasses during the heating, and producing an organic powder of biomass fuel and/or meat meal from the carcasses. Benefits of dehydrators include preventing the spread of disease to healthy animals, reducing contamination of groundwater and soil, processing dead animals quickly and during all seasons, and further transforming waste into a valuable resource. Existing dehydrators utilize a heater and blower system which are configured to run at 100% output for set predetermined periods. However, existing systems waste significant energy and have further require unnecessary time and labor due to the lack of efficient processing.

Therefore, improved mortality dehydrators which increase efficiency and reduce energy waste would be well received in the art of thermal dehydration.

### SUMMARY

In one embodiment, the present invention provides a method for thermal dehydration. The method includes receiving, by a receptor volume of a mortality dehydrator system, one or more animal carcasses; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; sensing, by a sensor system of the mortality dehydrator system, a temperature within the receptor volume; and turning on or off the heater system in response to sensed information from the sensor system.

In another embodiment, a mortality dehydrator system includes: a receptor volume configured to receive one or more animal carcasses; a heater system configured to heat the received one or more animal carcasses; a mixing system configured to mix the one or more animal carcasses during heating by the heater system; a blower system configured to circulate airflow during the heating by the heater system; a sensor system configured to detect a temperature within the receptor volume; and a control system configured to turn on or off the heater system in response to sensed information from the sensor system.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; automatically determining, by a control system of the mortality dehydrator system, a run time or a stop time for a dehydration process for dehydrating the received one or more animal carcasses; and automatically stopping, by the control system of the mortality dehydrator system, the dehydration process after the automatically determined run time or at the automatically determined stop time.

In another embodiment, a mortality dehydrator system includes: a receptor volume configured to receive one or more animal carcasses; a heater system configured to heat the received one or more animal carcasses; a mixing system configured to mix the one or more animal carcasses during heating by the heater system; a blower system configured to circulate airflow during the heating by the heater system; and a control system configured to automatically determine a run time or a stop time for a dehydration process and automatically stop the dehydration process after the automatically determined run time or at the automatically determined stop time.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; and turning off the heater system, by the control system, when the received one or more animal carcasses reaches a predetermined temperature.

In another embodiment, a mortality dehydrator system includes: a receptor volume configured to receive one or more animal carcasses; a heater system configured to heat the received one or more animal carcasses; a mixing system configured to mix the one or more animal carcasses during heating by the heater system; a blower system configured to circulate airflow during the heating by the heater system; and a control system configured to turn off the heater system when the received one or more animal carcasses reaches a predetermined temperature.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; and turning on the heater system, by the control system, when the received one or more animal carcasses reaches a predetermined temperature.

In another embodiment, a mortality dehydrator system includes: a receptor volume configured to receive one or more animal carcasses; a heater system configured to heat the received one or more animal carcasses; a mixing system configured to mix the one or more animal carcasses during heating by the heater system; a blower system configured to circulate airflow during the heating by the heater system; and a control system configured to turn on the heater system when the received one or more animal carcasses reaches a predetermined temperature.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; and adjusting the blower system, by the control system, in real time to meet environmental conditions during the dehydration process.

In another embodiment, a mortality dehydrator system includes: a receptor volume configured to receive one or more animal carcasses; a heater system including at least one heater configured to heat the received one or more animal carcasses; a mixing system configured to mix the one or more animal carcasses during heating by the heater system; a blower system configured to circulate airflow during the heating by the heater system; and a control system configured to adjust the blower system in real time to meet environmental conditions during the dehydration process.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; and determining, by the control system, a percentage of remaining product of the received one or more animal carcasses and turning off the heater system, by the control system, when the remaining product reaches a predetermined percentage.

In another embodiment, a mortality dehydrator system includes: a receptor volume configured to receive one or more animal carcasses; a heater system including at least one heater configured to heat the received one or more animal carcasses; a mixing system configured to mix the one or more animal carcasses during heating by the heater system; a blower system configured to circulate airflow during the heating by the heater system; and a control system configured to determine a percentage of remaining product of the received one or more animal carcasses and turn off the heater system when the remaining product reaches a predetermined percentage.

In another embodiment, a method for thermal dehydration includes: receiving one or more animal carcasses by a mortality dehydrator system; heating, by a heater system of the mortality dehydrator system, the received one or more animal carcasses; mixing, by a mixing system of the mortality dehydrator system, the received one or more animal carcasses; circulating airflow, by a blower system of the mortality dehydrator system, during the heating and mixing; detecting a temperature of one or more heaters of the heater system, by a sensor system of the mortality dehydrator system; and turning off the one or more heaters of the heater system, by the control system, when the temperature exceeds a predetermined temperature.

In another embodiment, a mortality dehydrator system includes: a receptor volume configured to receive one or more animal carcasses; a heater system including at least one heater configured to heat the received one or more animal carcasses; a mixing system configured to mix the one or more animal carcasses during heating by the heater system; a blower system configured to circulate airflow during the heating by the heater system; a sensor system configured to detect a temperature of one or more heaters of the heater system; and a control system configured to turn off the one or more heaters of the heater system when the temperature exceeds a predetermined temperature.

### BRIEF DESCRIPTION OF THE DRAWINGS

FIG. 1 is a schematic view of a mortality dehydrator system, in accordance with embodiments of the present invention.

FIG. 2 is a perspective view of the mortality dehydrator system of FIG. 1, in accordance with embodiments of the present invention.

FIG. 3 is a front view of the mortality dehydrator system of FIGS. 1 - 2, in accordance with embodiments of the present invention.

FIG. 4 is a side view of the mortality dehydrator system of FIGS. 1 - 3, in accordance with embodiments of the present invention.

FIGS. 5A and 5B are is-a perspective view of an interior of a receptor volume of the mortality dehydrator system of FIGS. 1 - 4, in accordance with embodiments of the present invention.

FIG. 6 depicts a flow chart of a method for thermal dehydration, in accordance with embodiments of the present invention.

FIG. 7 depicts a flow chart of another method for thermal dehydration, in accordance with embodiments of the present invention.

FIG. 8 depicts a flow chart of another method for thermal dehydration, in accordance with embodiments of the present invention.

FIG. 9 depicts a flow chart of another method for thermal dehydration, in accordance with embodiments of the present invention.

FIG. 10 depicts a flow chart of another method for thermal dehydration, in accordance with embodiments of the present invention.

FIG. 11 depicts a flow chart of another method for thermal dehydration, in accordance with embodiments of the present invention.

FIG. 12 depicts a flow chart of another method for thermal dehydration, in accordance with embodiments of the present invention.

### DETAILED DESCRIPTION

In brief overview, the present disclosure contemplates efficiently controlled thermal dehydration systems and methods which utilize sensor and control systems in order to save energy, time and labor. Further, processes for thermal dehydration are contemplated which utilize the sensor and control systems. In particular, processes include controlling temperature and time of exposure the ensure lethality of pathogenic organisms. Still further, methods contemplated include automatically determining timing or determining when to turn off a thermal dehydration process based on a sensed remaining percent of original product.

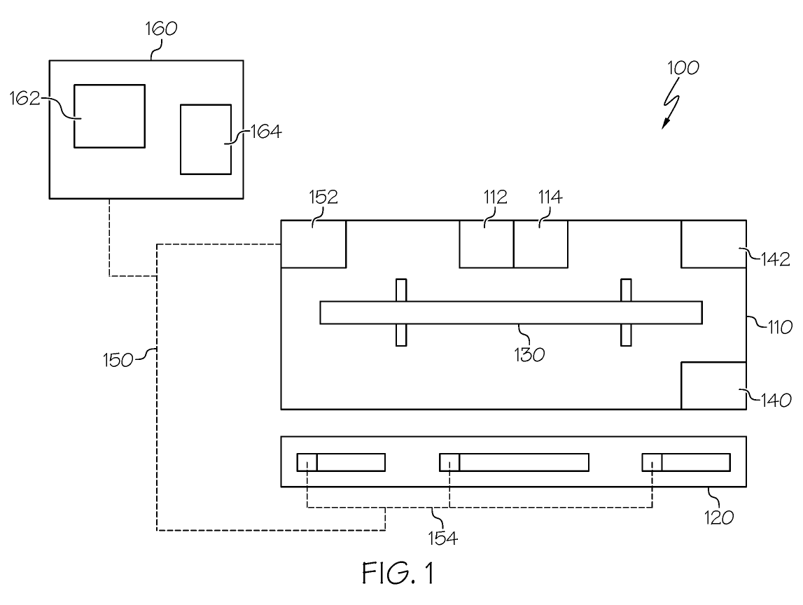

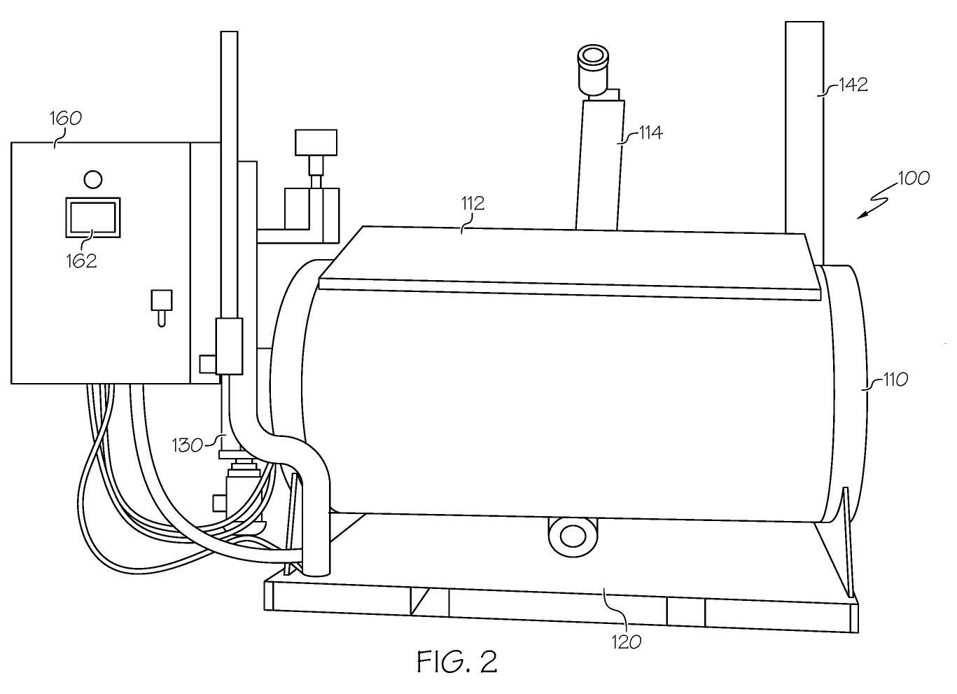

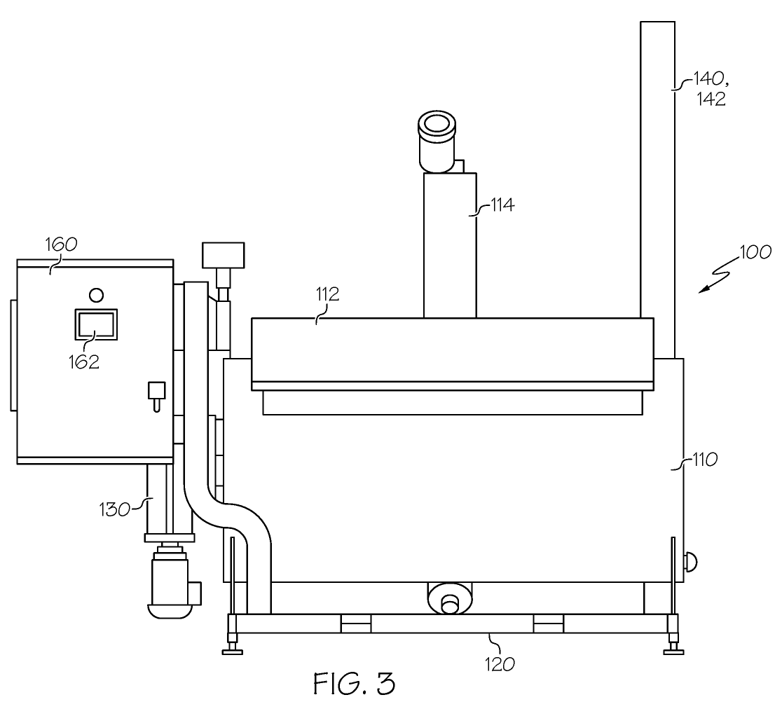

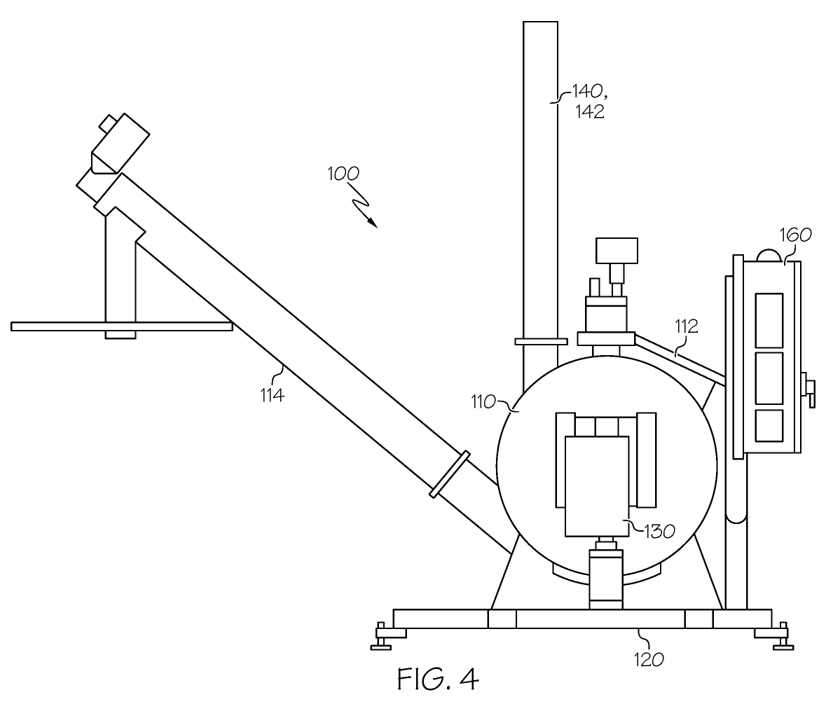

With reference now to FIG. 1, shown is a schematic view of a mortality dehydrator system 100, in accordance with embodiments of the present invention. FIG. 2 is a perspective view of the mortality dehydrator system 100 of FIG. 1, in accordance with embodiments of the present invention. FIG. 3 is a front view of the mortality dehydrator system 100 of FIGS. 1 - 2, in accordance with embodiments of the present invention. FIG. 4 is a side view of the mortality dehydrator system 100 of FIGS. 1 - 3, in accordance with embodiments of the present invention.

The mortality dehydrator system 100 includes a receptor volume 110 configured to receive one or more animal carcasses. Moreover, the mortality dehydrator system 100 includes a heater system 120 configured to heat the received one or more animal carcasses and a mixing system 130 configured to mix the one or more animal carcasses during heating by the heater system 120. The mortality dehydrator system 100 includes a blower system 140 configured to circulate airflow during the heating by the heater system 120, a sensor system 150 configured to detect a temperature within the receptor volume 110, and a control system 160 configured to turn on or off the heater system 120 in response to sensed information from the sensor system 150.

The receptor volume 110 may include a product input system 112 and a product output system 114. The product input system 112 may be a door, or the like, which is openable for providing closeable and openable and access to the receptor volume 110. The output system 114 may include a conveyance system and may be configured to automatically convey the dehydrated product to an output location.

The blower system 140 may include one or more fans or other air moving devices, for circulating air within the receiver volume 110. The blower system 140 may further include an exhaust 142, which may provide an outlet for air from the receptor volume 110. The blower system 140 may be controlled by the control system 160.

Likewise, the mixing system 130 may include one or more augers or other product movers within the receptor volume 110. The mixing system 130 may include a drive system, engine, or motor, along with an auger box or transmission system which may be configured to drive the one or more augers to mix the product during dehydration processes. The mixing system 130 and/or augers or transmission system thereof may be controlled by the control system 160.

The sensor system 150 may be configured to gather various data in real time during a thermal dehydration process. The sensor system 150 may include a first sensor system 152 including one or more sensors which are configured to detect a temperature of the received one or more animal carcasses during the dehydration process. In some embodiments, the first sensor system 152 may be one or more infrared sensors. The first sensor system 152 may be located within the receptor volume 110 in order to sense temperatures of the received product within the receptor volume 110. In other examples, the first sensor system 152 may include one or more thermocouples or any other temperature sensing mechanism configured to sense and provide temperature information of the product being dehydrated (e.g., animal carcasses) to the control system 160.

Still further, the sensor system 150 may include a second sensor system 154 which may be located in or at one or more heaters or heater panels 122 of the heater system 120. The second sensor system 154 may be configured to monitor the temperature of the heater panels 122 within the heater system 120 and provide this information to the control system 160. Thus, each of the sensor systems 152, 154 comprising the sensor system 150 may be in operable communication and provide sensed information (e.g., temperature information) to the control system 160. The second sensor system 154 may be configured to prevent overheating of the heat panels within the system.

Still further, the sensor system 150 may be inclusive of any other information gathering system which gathers operating information and provides such information to the control system 160. For example, the sensor system 150 may include a weight sensor system for determining the current weight of the received product within the receptor volume 110. Further, the sensor system 150 may include sensors relating to the operation of various other systems, including the blower system 140, the auger or mixer system 130, or the like.

The control system 160 may include an control panel or the like and may be configured to receive the sensed information from the sensor system 150 and may further include a user interface 162 which may be interacted with by an operator of the mortality dehydrator system 100 in order to provide input to the control system 160. The control system 160 may further include a computer system or computing environment 164 which may include one or more processors, short term or volatile memory, persistent storage or a storage drive for long term storage and the like. The one or more computer processors may be of any type now knownor to be developed in the future. The computer system may further include a network module which may include a collection of computer software, hardware, and firmware that allows computer 101 to communicate with other computers, for remote monitoring as described herein.

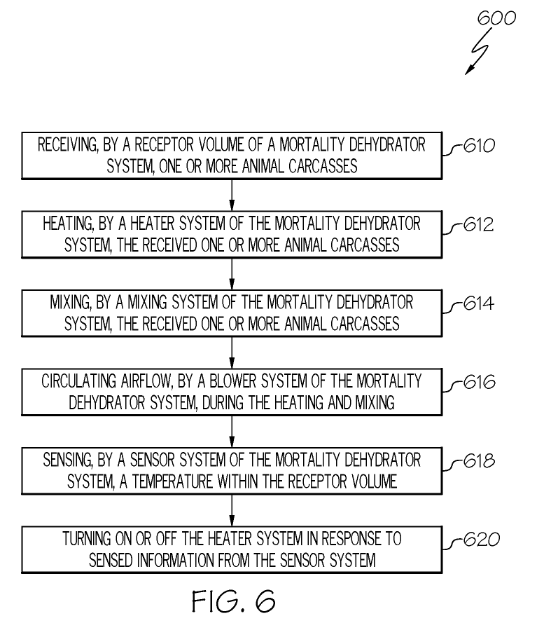

Computer-readable program instructions are typically loaded onto the computer system 164 to cause a series of operational steps to be performed by the one or more processors and thereby effect a computer-implemented method, such that the instructions thus executed will instantiate the methods specified in flowcharts and various process steps performed by the control system 160 in the methods of FIGS. 6 - 12, and/or narrative descriptions of computer- implemented methods included in this document (collectively referred to as "the inventive methods"). These computer-readable program instructions are stored in various types of computer-readable storage media, such as a cache and the other storage media discussed below. The program instructions, and associated data, are accessed by the one or more processors to control and direct performance of the inventive methods. In the computing environment 164, at least some of the instructions for performing the inventive methods may be stored in in persistent storage.

The control system 160 may be configured to automatically determine a run time or a stop time for a dehydration process and automatically stop the dehydration process after the automatically determined run time or at the automatically determined stop time. This automatic determination may be based on a preset (e.g., via the user interface 170) percentage of remaining product. Thus, the control system 160 may be configured to determine a percentage of remaining product of the received one or more animal carcasses and turn off the heater system 120 when the remaining product reaches a predetermined percentage.

The control system 160 may further be configured to turn off the heater system 120 when the received one or more animal carcasses reaches a predetermined temperature. This predetermined temperature may be a factory setting or a setting input by an operator via the user interface 170. The control system 160 may be configured to turn on the heater system 120 when the received one or more animal carcasses reaches a second (e.g., lower) predetermined temperature. Again, this second predetermined temperature may be a factory setting or a setting input by an operator via the user interface 170.

For example, the control system 160 may be in communication with the first sensor system 152 (e.g., infrared sensors) in order to monitor the product/mortality temperature to ensure the product/mortality temperature does not exceed 195 degrees and/or 200 degrees Fahrenheit. For example, if the product temperature as detected by the first sensor system 152 and communicated to the control system 160 reaches 195 degrees Fahrenheit, the control system 160 sends a control signal to the heater system 120 in order to turn off the one or more heaters thereof to prevent burning of product. The heaters of the heater system 120 may be automatically turned on when the product temperature as detected by the first sensor system 152 and communicated to the control system 160 reaches a preset temperature (e.g., 190 degrees Fahrenheit) and resumes the dehydration process.

Still further, the control system 160 may be configured to turn off the one or more heaters of the heater system when the temperature sensed by the second sensor system 154 of the one or more heaters or heater panels 122 exceeds a predetermined temperature.

Moreover, the control system 160 may be configured to adjust the blower system 140 in real time to meet environmental conditions during the dehydration process. For example, the blower system 140 may be configured to run at 40 cubic feet per minute (cfm) in one embodiment, which could change to meet environmental conditions. For example, the blower system 140 may be controlled by the control system 160 to be turned off or even increased to 100 cfm or more. For example, in one embodiment, the control system 160 may be configured to turn off the blower until the product is detected to reach 190 degrees Fahrenheit. The blower system 140 may remain off for a predetermined time (e.g., 30 minutes) once the product reaches 190 degrees Fahrenheit in order to ensure lethality of harmful bacteria and pathogens. After the 190 degrees Fahrenheit and time period setting is met, the blower system 140 may be configured to turn back on in order to resume the remainder of the dehydration cycle.

Thus, the control system 160 may be configured to maintain set heater temperatures. If the set temperature exceeds a preset or predetermined or maximum temperature setting, the control system 160 may be configured to lock the heater system 160 and/or turn the heater system 160 unit off.

Still further, the control system 160 may be configured to record and store data of each batch or run cycle minute by minute and may be configured to record a start weight / current weight/ current temperature of product in order to monitor, control, prevent burning and to ensure proper temperature has been met to destroy all harmful bacteria and pathogens. Additionally, the control system 160 may enable operation of the TDU (Thermal Dehydration Unit) using remote inputs. Other recording operations of each component including motor speeds, amp draw, blower cfm output and each heater percentage output and current temp may be recorded and stored either locally or remotely. The control system 160 may be configured to store data for a predetermined time period, such as a 30 day run cycle. Further, the control system 160 may be configured to provide this data to users at periodic intervals, including after each run cycle. For example, the control system 160 may automatically generate an email with attached or provided data related to a run cycle to an operator after such run cycle completes. In addition to remote controlling of the control system 160 and/or the mortality dehydrator system 100, the control system 160 may include internet access capabilities in order to enable cloud storage and/or services, and to allow remote monitoring, diagnosing of problems, and the setting of various individual settings.

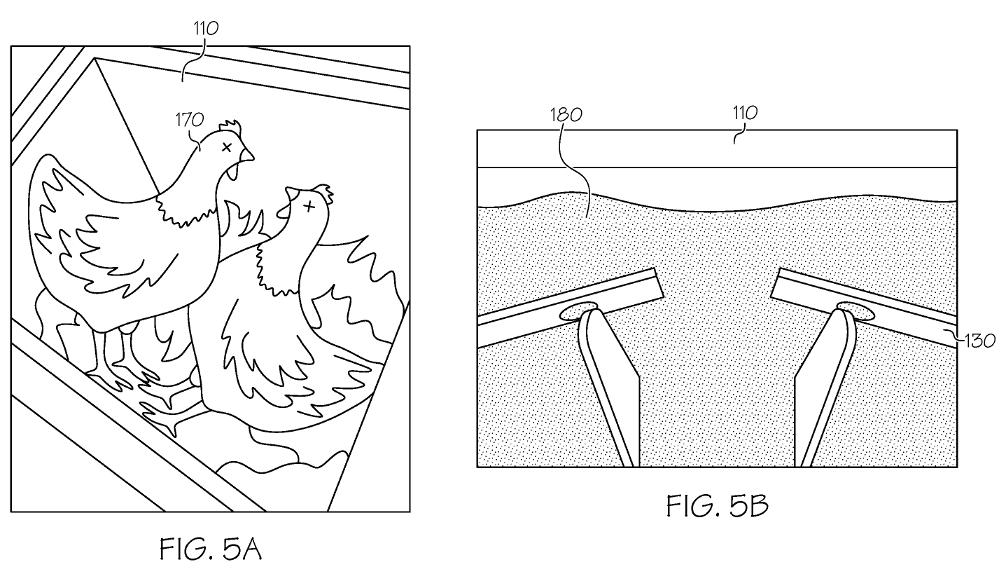

FIG. 5 is a perspective view of an interior 115 of a receptor volume 110 of the mortality dehydrator system 100 of FIGS. 1 - 4, in accordance with embodiments of the present invention. As shown, the interior 115 of the receptor volume 110 includes the mixer system 130 which may be configured to turn within the interior 115 of the receptor volume 110. As shown in FIG. 5, the interior 115 of the receptor volume may first receive one or more animal carcasses 170. Once the dehydration process completes, a dehydrated product 180 remains. The receptor volume 110 may be a drum, tank, barrel, container or the like, configured to receive the carcasses of animals for dehydration. For example, the receptor volume 110 may be a drum having a 37 inch diameter and an 84 inch length, for example. However, embodiments are not limited to these dimensions, and any larger or smaller dimensions may be contemplated. The receptor volume 110 may be generally cylindrical in shape in order to accommodate an auger (mixer) system to promote mixing of the received animal carcass 170 and/or dehydrated product 180.

Various methods are further contemplated, as exemplified by FIGS. 6 - 12. While the methods described in FIGS. 6 - 12 include specific sequences of steps, it should be understood that the steps described may be performed in any order. Further, various methods combining steps described in one or more of the methods exemplified below may be incorporated into methods. Still further, various methods may incorporate and may be performed by the structure and systems (i.e., the mortality dehydrator system 100 described hereinabove).

FIG. 6 depicts a flow chart of a method 600 for thermal dehydration, in accordance with embodiments of the present invention. The method 600 includes a first step 610 of receiving, by a receptor volume of a mortality dehydrator system, one or more animal carcasses. The method 600 includes a step 612 of heating, by a heater system of the mortality dehydrator system, the received one or more animal carcasses. The method 600 includes a step 614 of mixing, by a mixing system of the mortality dehydrator system, the received one or more animal carcasses. The method 600 further includes a step 616 of circulating and/or exhausting airflow, by a blower system of the mortality dehydrator system, during the heating and mixing. The method further includes a step 618 of sensing, by a sensor system of the mortality dehydrator system, a temperature of carcasses and/or dehydrated product within the receptor volume, and a step 620 of turning on or off the heater system in response to sensed information from the sensor system.

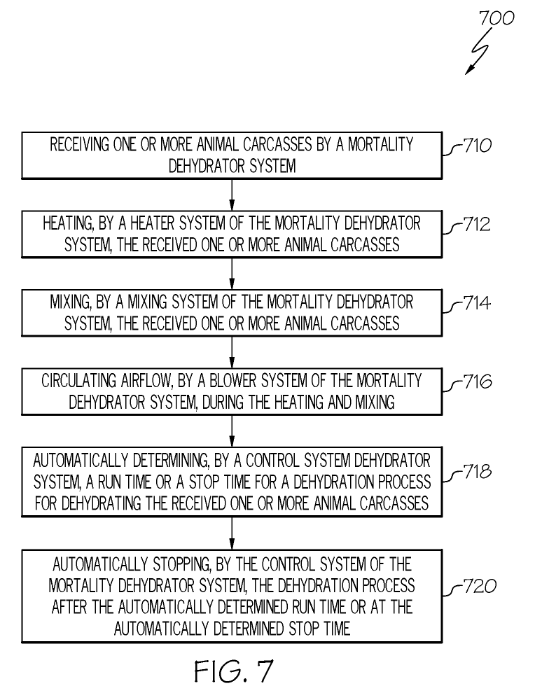

FIG. 7 depicts a flow chart of another method 700 for thermal dehydration, in accordance with embodiments of the present invention. The method 700 includes a first step 710 of receiving one or more animal carcasses by a mortality dehydrator system. The method 700 includes a step 712 of heating, by a heater system of the mortality dehydrator system, the received one or more animal carcasses. The method 700 includes a step 714 of mixing, by a mixing system of the mortality dehydrator system, the received one or more animal carcasses. The method 700 includes a step 716 of circulating and/or exhausting airflow, by a blower system of the mortality dehydrator system, during the heating and mixing. Further, the method 700 includes a step 718 of automatically determining, by a control system of the mortality dehydrator system, a run time or a stop time for a dehydration process for dehydrating the received one or more animal carcasses, and a further step 720 of automatically stopping, by the control system of the mortality dehydrator system, the dehydration process after the automatically determined run time or at the automatically determined stop time.

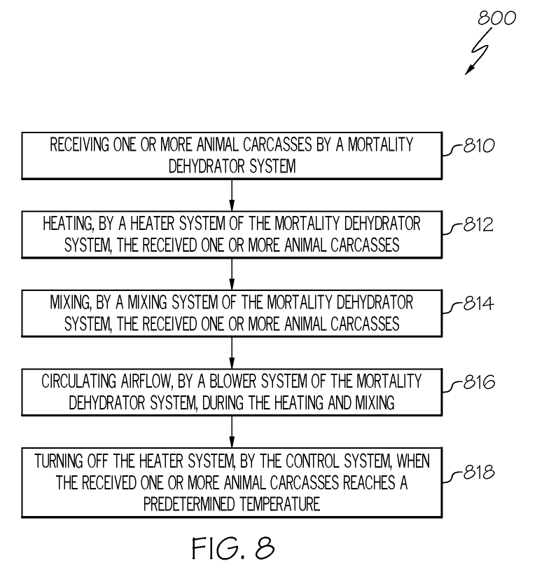

FIG. 8 depicts a flow chart of another method 800 for thermal dehydration, in accordance with embodiments of the present invention. The method 800 includes a first step 810 of receiving one or more animal carcasses by a mortality dehydrator system. The method 800 includes a step 812 of heating, by a heater system of the mortality dehydrator system, the received one or more animal carcasses. The method 800 includes a step 814 of mixing, by a mixing system of the mortality dehydrator system, the received one or more animal carcasses. The method 800 includes a step 816 of circulating and/or exhausting airflow, by a blower system of the mortality dehydrator system, during the heating and mixing. The method 800 further includes a step 818 of turning off the heater system, by the control system, when the received one or more animal carcasses reaches a predetermined temperature. In one embodiment, the predetermined temperature for turning off the heater system may be 195 degrees Fahrenheit.

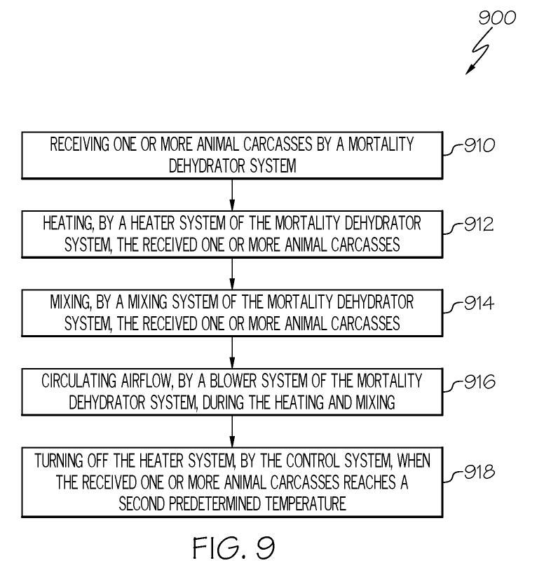

FIG. 9 depicts a flow chart of another method 900 for thermal dehydration, in accordance with embodiments of the present invention. The method 900 includes a first step 910 of receiving one or more animal carcasses by a mortality dehydrator system. The method 900 includes a step 912 of heating, by a heater system of the mortality dehydrator system, the received one or more animal carcasses. The method 900 includes a step 914 of mixing, by a mixing system of the mortality dehydrator system, the received one or more animal carcasses. The method 900 includes a step 916 of circulating and/or exhausting airflow, by a blower system of the mortality dehydrator system, during the heating and mixing. The method 900 further includes a step 918 of turning on the heater system, by the control system, when the received one or more animal carcasses reaches a predetermined temperature. For example, this step 918 may occur following the turning off of the heater system when the control system determines that the heater system has reached a higher temperature. The lower predetermined temperature of the method 900 may be, for example, 190 degrees Fahrenheit in an example embodiment.

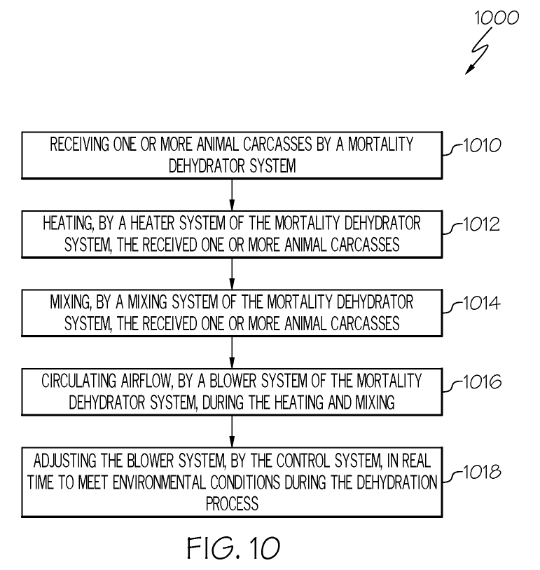

FIG. 10 depicts a flow chart of another method for thermal dehydration, in accordance with embodiments of the present invention. The method 1000 includes a first step 1010 of receiving one or more animal carcasses by a mortality dehydrator system. The method 1000 includes a step 1012 of heating, by a heater system of the mortality dehydrator system, the received one or more animal carcasses. The method 1000 includes a step 1014 of mixing, by a mixing system of the mortality dehydrator system, the received one or more animal carcasses. The method 1000 includes a step 1016 of circulating and/or exhausting airflow, by a blower system of the mortality dehydrator system, during the heating and mixing. Further, the method includes a step 1018 of adjusting the blower system, by the control system, in real time to meet environmental conditions during the dehydration process.

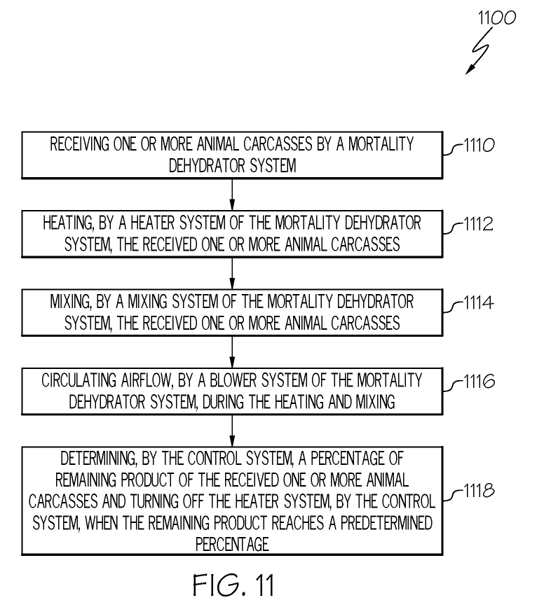

FIG. 11 depicts a flow chart of another method for thermal dehydration, in accordance with embodiments of the present invention. The method 1100 includes a first step 1110 of receiving one or more animal carcasses by a mortality dehydrator system. The method 1100 includes a step 1112 of heating, by a heater system of the mortality dehydrator system, the received one or more animal carcasses. The method 1100 includes a step 1114 of mixing, by a mixing system of the mortality dehydrator system, the received one or more animal carcasses. The method 1100 includes a step 1116 of circulating and/or exhausting airflow, by a blower system of the mortality dehydrator system, during the heating and mixing. The method further includes a step 1118 of determining, by the control system, a percentage of remaining product of the received one or more animal carcasses and turning off the heater system, by the control system, when the remaining product reaches a predetermined percentage.

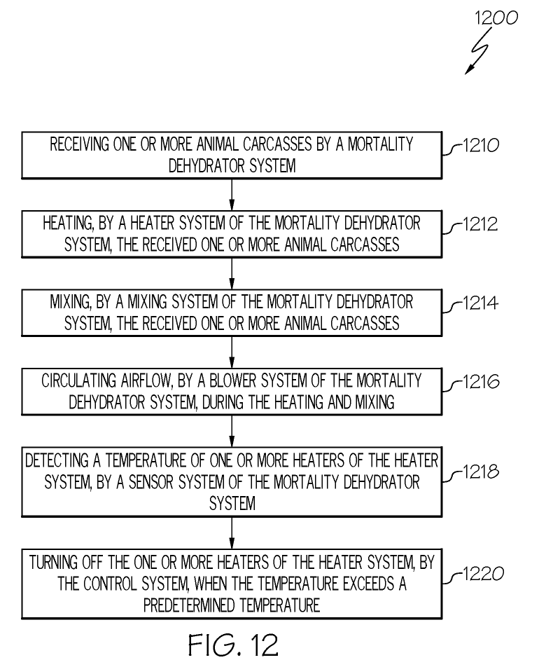

FIG. 12 depicts a flow chart of another method for thermal dehydration, in accordance with embodiments of the present invention. The method 1200 includes a first step 1210 of receiving one or more animal carcasses by a mortality dehydrator system. The method 1200 includes a step 1212 of heating, by a heater system of the mortality dehydrator system, the received one or more animal carcasses. The method 1200 includes a step 1214 of mixing, by a mixing system of the mortality dehydrator system, the received one or more animal carcasses. The method 1200 includes a step 1216 of circulating and/or exhausting airflow, by a blower system of the mortality dehydrator system, during the heating and mixing. The method 1200 includes a step 1218 of detecting a temperature of one or more heaters of the heater system, by a sensor system of the mortality dehydrator system, and a further step 1220 of turning off the one or more heaters of the heater system, by the control system, when the temperature exceeds a predetermined temperature.

Various methods further may include additional steps, such as adjusting the blower system, by the control system, in real time to meet environmental conditions during the dehydration process. For example, methods may include turning off the blower until the product is detected to reach 190 degrees Fahrenheit. Methods may include maintaining the blower system 140 in an off state for a predetermined time (e.g., 30 minutes) once the product reaches 190 degrees Fahrenheit in order to ensure lethality of harmful bacteria and pathogens. After the 190 degrees Fahrenheit and time period setting is met, methods may include turning back on the blower system 140 in order to resume the remainder of the dehydration cycle. In other examples, the blower may be adjusted if the weight of the original product provided into the receptor volume is above a predetermined amount.

Methods may further include locking off the heaters and/or heater plates of the heater system to prevent burning of product when a burn condition is detected by sensors and information indicating this condition is provided to the control system. Methods may include automatically turning on the heaters when the product reaches a lower temperature.

Methods may further include recording and/or storing data of each batch or run cycle minute by minute. Methods may include recording a start weight, current weight, and/or current temperature of product. Methods may include monitoring and controlling the system to prevent burning and to ensure proper temperature has been met to destroy all harmful bacteria and pathogens. Methods may further include recoding the operation of each component, such as motor speeds, amp draw, blower cfm output and each heater percentage output and current temp. Methods may include storing data for each run cycle for a predetermined number of days (e.g., 30). Methods may include sending the data of each run cycle to an external digital location such as a specific email address. Methods may include providing the system with internet access and monitoring and/or diagnosing problems with the system remotely via the internet access. Methods may further include resetting and/or changing settings on the system remotely.

Using the efficiencies described hereinabove, the present invention may be configured to process 1300 pounds of product in 13 or 14 hours, at significantly reduced times and up to 2,200 pounds relative to state of the art systems prior to the present invention. In an example embodiment, if product over 300 pounds is detected, the blower may be reduced to 50% or cut off completely during an initial heating phase in which the heater and mixer remain on. Once the temperature of the product reaches 190 degrees Fahrenheit, the blower system may remain off for another 30 minutes in order to burn pathogens and bacteria from the product. Once this occurs, the blower system may then turn on and the dehydration process may continue.

Moreover, the present system may be configured to detect low weight product inputs and automatically adjust the process for dehydration accordingly.

Still further, embodiments of the present invention include utilizing galvanized steel components in order to ensure durability.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for thermal dehydration comprising:
receiving, by a receptor volume of a mortality dehydrator system, one or more animal carcasses;
heating, by a heater system of the mortality dehydrator system, the received one or more animal carcasses;
mixing, by a mixing system of the mortality dehydrator system, the received one or more animal carcasses;
circulating airflow, by a blower system of the mortality dehydrator system, during the heating and mixing;
sensing, by a sensor system of the mortality dehydrator system, a temperature within the receptor volume; and
turning on or off the heater system in response to sensed information from the sensor system.

2. The method of claim 1, further comprising:
automatically determining, by the control system of the mortality dehydrator system, a run time or a stop time for a dehydration process for dehydrating the received one or more animal carcasses; and
automatically stopping, by the control system of the mortality dehydrator system, the dehydration process after the automatically determined run time or at the automatically determined stop time.

3. The method of claim 1, further comprising detecting, by the sensor system of the mortality dehydrator system, a temperature of the received one or more animal carcasses during the dehydration process.

4. The method of claim 3, wherein the sensor system includes one or more infrared sensors.

5. The method of claim 3, further comprising turning off the heater system, by the control system, when the received one or more animal carcasses reaches a predetermined temperature.

6. The method of claim 5, further comprising turning on the heater system, by the control system, when the received one or more animal carcasses reaches a second predetermined temperature.

7. The method of claim 1, further comprising detecting a temperature of one or more heaters of the heater system, by the sensor system of the mortality dehydrator system.

8. The method of claim 7, further comprising turning off the one or more heaters of the heater system, by the control system, when the temperature exceeds a predetermined temperature.

9. The method of claim 1, further comprising adjusting the blower system, by the control system, in real time to meet environmental conditions during the dehydration process.

10. The method of claim 1, further comprising determining, by the control system, a percentage of remaining product of the received one or more animal carcasses and turning off the heater system, by the control system, when the remaining product reaches a predetermined percentage.

11. A mortality dehydrator system comprising:
a receptor volume configured to receive one or more animal carcasses;
a heater system configured to heat the received one or more animal carcasses;
a mixing system configured to mix the one or more animal carcasses during heating by the heater system;
a blower system configured to circulate airflow during the heating by the heater system;
a sensor system configured to detect a temperature within the receptor volume; and
a control system configured to turn on or off the heater system in response to sensed information from the sensor system.

12. The system of claim 11, wherein the control system is configured to automatically determine a run time or a stop time for a dehydration process and automatically stop the dehydration process after the automatically determined run time or at the automatically determined stop time.

13. The system of claim 11, wherein the sensor system is configured to detect a temperature of the received one or more animal carcasses during the dehydration process.

14. The system of claim 13, wherein the sensor system includes one or more infrared sensors.

15. The system of claim 13, wherein the control system is configured to turn off the heater system when the received one or more animal carcasses reaches a predetermined temperature.

16. The system of claim 15, wherein the control system is configured to turn on the heater system when the received one or more animal carcasses reaches a second predetermined temperature.

17. The system of claim 11, wherein the sensor system is configured to detect a temperature of one or more heaters of the heater system.

18. The system of claim 17, wherein the control system is configured to turn off the one or more heaters of the heater system when the temperature exceeds a predetermined temperature.

19. The system of claim 11, wherein the control system is configured to adjust the blower system in real time to meet environmental conditions during the dehydration process.

20. The system of claim 11, wherein the control system is configured to determine a percentage of remaining product of the received one or more animal carcasses and turn off the heater system when the remaining product reaches a predetermined percentage.
